(19) United States
(12) Patent Application Publication
(10) Pub. No.: US 2007/0064232 A1
(43) Pub. Date: Mar. 22, 2007

(54) Method and system for measuring overlay of semiconductor device

(75) Inventors: Duck-Sun Yang, Seoul (KR); Yun-Hee Cho, Seoul (KR); Seok-Hwan Oh, Suwon-si (KR); Gi-Sung Yeo, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/513,181

(22) Filed: Aug. 31, 2006

(30) Foreign Application Priority Data
Sep. 20, 2005 (KR) 10-2005-0087347

(51) Int. Cl. G01B 11/00

(52) U.S. Cl. 356/400

(57) ABSTRACT

Described is a method and system for measuring overlay of a semiconductor device. The method may include obtaining reference sample data and misaligned sample data from scattering data of a reference sample and misaligned samples, assigning reference fitting values based on the reference sample data and the misaligned sample data, collecting target wafer scattering data from a target wafer, evaluating a target wafer fitting value based on the reference sample data and the target wafer scattering data and comparing the target wafer fitting value with the reference fitting values to determine a target wafer misaligned value relating to the overlay between the first pattern and the second pattern of a target wafer.

### PRIORITY STATEMENT

This U.S. non-provisional patent application claims priority under 35 U.S.C. § 119 to Korean Patent Application 2005-87347 filed on Sep. 20, 2005, the entire contents of which are hereby incorporated by reference.

### BACKGROUND

1. Field of Invention

Example embodiments of the present invention are directed towards a method and system for measuring overlay of patterns in a semiconductor device.

2. Description of Related Art

In manufacturing semiconductor devices, many processes may be performed on a wafer used as a semiconductor substrate. Such processes may include a photolithography operation for defining patterns on the wafer, an etching operation for selectively removing material layers on the wafer, an implanting operation for injecting impurities into the wafer, etc. By repeating one or more of these processes, semiconductor devices may be formed to have layout patterns based on designed specifications.

After various processes are completed and a semiconductor device is formed, a measurement may be obtained from the semiconductor device to confirm the results of the processes and that a semiconductor device meets its design specifications. For example, the thickness of a film deposited on a semiconductor substrate, the amount of etching, the amount of overlay, etc., may be measured to confirm the results of one or more of the various processes.

Overlay measurement is an operation for checking an alignment state between a preceding pattern and a subsequent pattern. Overlay data may be numerical values representing the alignment between the preceding and subsequent patterns. The alignment between the preceding and subsequent patterns may be regarded as important parameters in fabricating semiconductor devices. If the misalignment between the preceding and subsequent patterns increases, defects may occur in the semiconductor devices and/or the semiconductor devices may fail.

As the integration of semiconductor devices increases, the preceding and subsequent patterns become finer and/or smaller and the allowance for misalignment between the preceding and subsequent patterns may become smaller. Thus, the overlay between the preceding and subsequent patterns should be precisely regulated.

### SUMMARY

Example embodiments of the present invention are directed to a method and system for measuring overlay, capable of precisely inspecting an alignment state between a first pattern formed by a first operation and a second pattern formed by a second operation.

An example embodiment of the present invention provides a method of measuring overlay between a first pattern formed by a first operation and a second pattern formed by a second operation. The method may include preparing a reference sample having a misaligned value between the first and second patterns of zero, and a plurality misaligned samples having misaligned values between the first and second patterns larger than zero and different from each other; conducting scattering measurement to the reference sample with light to obtain reference sample data; conducting scattering measurement to the misaligned samples with light to obtain misaligned sample data related to the reference sample data; evaluating reference fitting values based on the reference and misaligned sample data; extracting a fitting value of a target wafer; and comparing the fitting value of the target wafer with the reference fitting values to determine a misaligned value of the target wafer.

According to an example embodiment of the present invention, the reference sample data may include a plurality of wavelength-classified reference sample data obtained by scattering measurement to the reference sample with a plurality of light different in wavelength domains. In this example embodiment, the misaligned sample data may be obtained by scattering measurement to the misaligned samples with the plurality of light. The misaligned sample data may include a plurality of misaligned sample data corresponding to each of the wavelength-classified reference sample data. In this example embodiment, the evaluating the reference fitting values may include evaluating a plurality of wavelength-classified fitting value groups. Each of the wavelength-classified fitting value groups may include a plurality of reference fitting values evaluated from each of the wavelength-classified reference sample data and the plurality of misaligned sample data corresponding to each of the wavelength-classified reference sample data. In this example embodiment, the method may also include selecting one of the wavelength-classified fitting value groups based on linearity of the relation between the misaligned values and the plurality of reference fitting values.

According to an example embodiment of the present invention, the reference and misaligned sample data may be used with a physical quantity that is one selected from intensity of P-polarized light, phase difference of P-polarized light, intensity of S-polarized light, and phase difference of S-polarized light.

According to an example embodiment of the present invention, a plurality of reference sample data may be provided and each reference sample data may correspond to one of the plurality of physical quantities. The misaligned sample data may include a plurality of the misaligned sample data corresponding to each one of plurality of the reference sample data. The evaluating the reference fitting values may include evaluating a plurality of reference fitting value groups. Each of the reference fitting value groups may include a plurality of reference fitting values evaluated from each of the reference sample data and the plurality of misaligned sample data corresponding to each of the reference sample data. In this example embodiment, the method may further include setting weight values of percentage for each reference fitting value group. Further, in this example embodiment, the extracting the fitting values of the target wafer and determining the misaligned value of the target wafer may include extracting the fitting values of the target wafer in correspondence with the reference fitting value groups; comparing the fitting values of the target wafer with the reference fitting value groups to determine preliminary misaligned values of the target wafer; and applying the weight values to the preliminary misaligned values to determine the misaligned value of the target wafer.

According to an example embodiment of the present invention, each of the reference sample data may include a plurality of wavelength-classified reference sample data corresponding to each of the physical quantities. The plurality of wavelength-classified reference data may be obtained by scattering measurement to the reference sample with a plurality of light different in wavelength domains. In this example embodiment, the misaligned sample data may include a plurality of misaligned sample data corresponding to each of the wavelength-classified reference sample data and being obtained by a scattering measurement performed on the misaligned samples with the plurality of light different in wavelength domains. In this example embodiment, the evaluating the reference fitting values may include evaluating a plurality of wavelength-classified fitting value groups. Each of the wavelength-classified fitting value groups may include a plurality of reference fitting values evaluated from each of the wavelength-classified reference sample data and the plurality of misaligned sample data corresponding to each of the wavelength-classified reference sample data. In this example embodiment, the method may further include selecting one of the wavelength-classified fitting value groups corresponding to each of the physical quantities. The wavelength-classified fitting value group may be selected based on linearity in a relation between the misaligned values and the plurality of reference fitting values.

An example embodiment of the present invention provides a method of measuring overlay between a first pattern and a second pattern. The method may include obtaining reference sample data and misaligned sample data from scattering data of a reference sample and at least one misaligned sample, respectively; assigning reference fitting values based on the reference sample data and the misaligned sample data; collecting target wafer scattering data from a target wafer; evaluating a target wafer fitting value based on the reference sample data and the target wafer scattering data; and comparing the target wafer fitting value with the reference fitting values to determine a target wafer misaligned value relating to the overlay between the first pattern and the second pattern of a target wafer.

An example embodiment of the present invention provides a system for measuring overlay between a first pattern formed by a first operation and a second pattern formed by a second operation. The system may include a scattering measurement block conducting an operation of scattering measurement to a reference sample having a misaligned value of zero between the first and second patterns, and misaligned samples having misaligned values larger than zero and different from each other, obtaining reference sample data and a plurality of misaligned sample data, and obtaining scattering data of a target wafer; a storage unit storing the plurality of data obtained by the scattering measurement block; and a control operation unit evaluating reference fitting values, from the reference and misaligned sample data, in correspondence with the misaligned values, evaluating a fitting value of a target wafer from the reference sample and scattering data, and comparing the fitting value of the target wafer with the reference fitting values to determine a misaligned value of the target wafer.

### BRIEF DESCRIPTION OF THE FIGURES

Non-limiting and non-exhaustive example embodiments of the present invention will be described with reference to the following figures, wherein like reference numerals refer to like parts throughout the various figures unless otherwise specified.

FIG. 1 is a schematic diagram illustrating an overlay measuring system in accordance with an example embodiment of the present invention.

FIG. 2 is a sectional diagram illustrating example patterns for which an overlay measurement may be obtained in accordance with an example embodiment of the present invention.

FIG. 3 is a sectional diagram illustrating example patterns for which an overlay measurement may be obtained in accordance with an example embodiment of the present invention.

FIG. 4a is a flow chart showing a method of measuring overlay of a semiconductor in accordance with an example embodiment of the present invention.

FIG. 4b is a flow chart showing a modified method of measuring overlay of a semiconductor in accordance with an example embodiment of the present invention.

### DETAILED DESCRIPTION OF EXAMPLE EMBODIMENTS

Example embodiments will be described below in more detail with reference to the accompanying figures. The invention may, however, be embodied in different forms and should not be construed as limited to the example embodiments set forth herein. Rather, these example embodiments are provided so that this disclosure will be thorough and complete, and will fully convey the scope of the invention to those skilled in the art.

Specific structural and functional details disclosed herein are merely representative for purposes of describing example embodiments of the present invention. It should be understood, that all modifications, equivalents, and alternatives to the example embodiments fall within the scope of the invention.

It will be understood that, although the terms first, second, etc. may be used herein to describe various components, these components should not be limited by these terms. These terms are only used to distinguish one component from another. For example, a first component could be termed a second component, and similarly, a second component could be termed a first component, without departing from the scope of the invention. As used herein, the term “and/or” includes any and all combinations of one or more of the associated listed items.

It will also be understood that if a component is referred to as being “connected” or “coupled” to another component, it can be directly connected or coupled to the other components or intervening components may be present. In contrast, when a component is referred to as being “directly connected” or “directly coupled” to another component, there are no intervening components present. Other words used to describe a relationship between components should be interpreted in a similar fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular terms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Hereinafter, example embodiments will be described in conjunction with the accompanying figures.

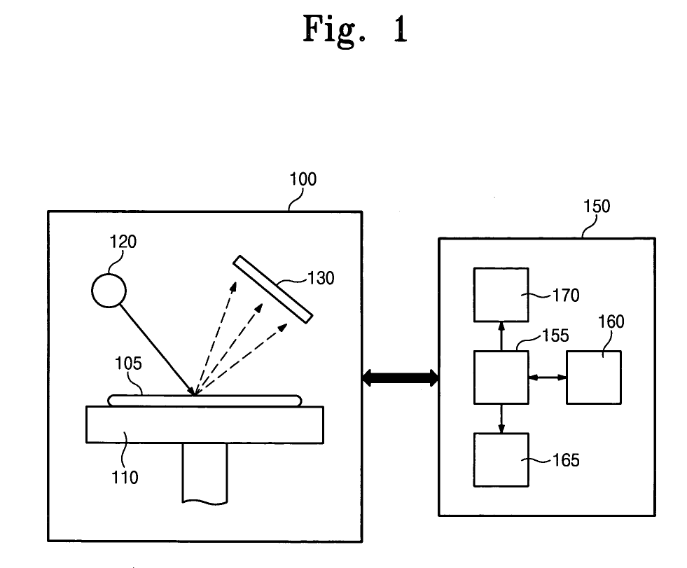

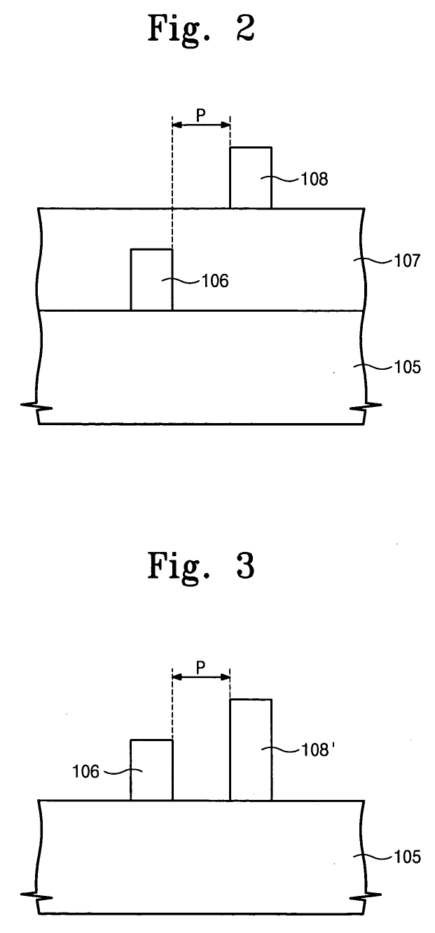

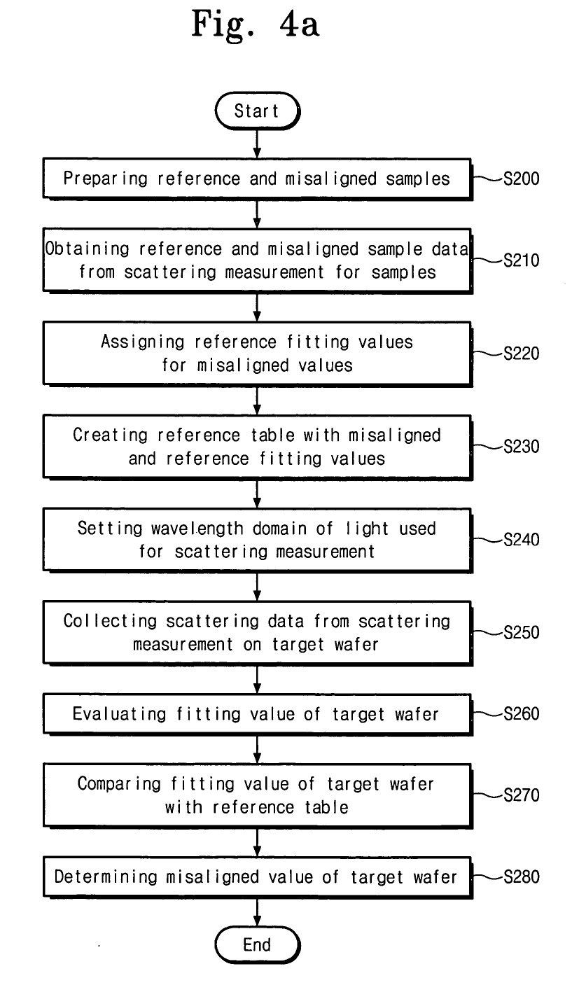

FIG. 1 is a schematic diagram illustrating an overlay measuring system in accordance with an example embodiment of the present invention. FIG. 2 is a sectional diagram illustrating example patterns from which an overlay measurement may be obtained according to an example embodiment of the present invention, and FIG. 3 is a sectional diagram illustrating other example patterns from which an overlay measurement may be obtained according to an example embodiment of the present invention.

Referring to FIG. 1, an overlay measuring system according to an example embodiment of the present invention may include a scattering measurement block 100 and a controller 150. The scattering measurement block 100 may include a wafer chuck 110, a light source 120 and a detector 130. A wafer 105 may be loaded on the wafer chuck 110. The light source 120 may irradiate light toward the wafer chuck 110 to measure overlay on the wafer 105. The light source 120 may be arranged over the wafer chuck 110. The detector 130 may sense a physical quantity of light scattered from the wafer chuck 110. For example, the light source 120 irradiates light toward the wafer 105 loaded on the wafer chuck 110, the light irradiated on the surface of the wafer 105 is scattered therefrom, and then the detector 130 senses a physical quantity of the scattered light. According to a surface condition of the wafer 105, the irradiated light may be variously scattered and may change the physical quantity sensed at the detector 130.

The physical quantity obtained by the detector 130 may be data about light intensity and/or phase difference. The light source 120 may be arranged to irradiate P or S-polarized light toward the wafer chuck 110. The P-polarized light may be configured to have an incidence field vertical to a progressing direction, where the incidence field is polarized horizontally to an incident plane. The S-polarized light may be configured to have an incidence field vertical to a progressing direction, where the incidence field is polarized vertically to an incident plane. In other words, the physical quantity obtained by the detector 130 may be intensity and/or phase difference of the P-polarized light or intensity and/or phase difference of the S-polarized light. The detector may be designed to sense one or more items from the aforementioned physical quantities.

The controller 150 may include a control operation unit 155, a storage unit 160, an input unit 165, and an output unit 170. The storage unit 160 may retain data obtained from the scattering measurement block 100. The control operation unit 155 executes operation, comparison and control of the obtained data. The storage unit 160 may store various data generated from the control operation unit 155. The input unit 165 may be a keyboard, for example. The output unit 170 may be configured to output various forms of data being controlled by the control operation unit 155. The output unit 170 may be a monitor or printer, for example.

Referring to FIGS. 2 and 3, on the wafer 105, a first pattern 106 may be formed by a first operation and a second pattern 108 may be formed by a second operation. The second operation may be carried out subsequent to the first operation. For example, the second pattern 108 may be a photoresist pattern formed by a photolithography process or a real pattern formed after completing an etching process. In other words, the overlay measurement may be conducted after completing a photolithography process and/or after completing an etching process, for example.

A material film 107 may cover the first pattern 106. The second pattern 108 may be arranged on the material film 107. The bottom of the second pattern 108 may be at a level higher than the top of the first pattern 106 as shown in the example of FIG. 2. The first pattern 106 may be separated and/or isolated from the second pattern 108 by a desired and/or predetermined distance P.

As illustrated in the example of FIG. 3, a second pattern 108′ may be arranged at the same level as the first pattern 106. For example, after forming the first pattern 106, the second pattern 108′ may be arranged adjacent to the first pattern 106. The first and second patterns 106 and 108′ may be separated and/or isolated from each other by a desired and/or a predetermined distance P.

The first and second patterns 106, 108 and 108′ may be arranged within the territory of semiconductor chip, e.g., within a chip area, and may correspond to real patterns belonging to the semiconductor chip. Further, the first and second patterns 106, 108 and 108′ may be arranged on scribing lines among chip areas. That is, the first and second patterns 106, 108 and 108′ may be patterns from which an overlay measurement is desired.

As shown in FIGS. 2 and 3, the first and second patterns 106, 108 and 108′ may be arranged in the form of bars, which may be separated and/or isolated from each other by the distance P. Further, the first and second patterns 106, 108 and 108′ may be provided in the form of grooves separated and/or isolated from each other. Further, if the second pattern 108 is at a level higher than the first pattern 106 as shown in FIG. 2, the first and second patterns 106 and 108 may be arranged to partially overlap with each other. The first and second patterns 106, 108 and 108′ may function as general overlay keys arranged along scribing lines among chips on the wafer. Resultantly, the first and second patterns 106, 108, and 108′ may be provided in all configurations available for the overlay measurement.

For convenience of explanation, the first and second patterns 106 and 108′ of FIG. 3 will be referred to during an explanation for obtaining an overlay measurement according to an example embodiment of the present invention.

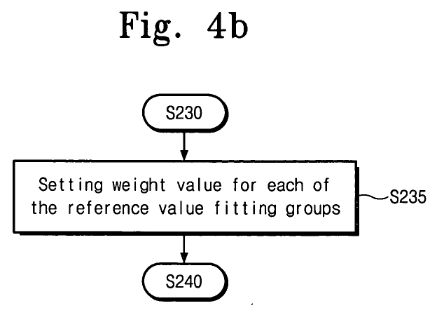

FIG. 4a is a flow chart showing a method of measuring overlay of a semiconductor according to an example embodiment of the present invention.

Referring to FIGS. 1, 3, and 4a, a method of measuring overlay of a semiconductor according to an example embodiment of the present may begin with preparing a reference sample and one or more misaligned samples S200. The reference sample may be a wafer having a misaligned value between the first and second patterns 106 and 108′ of zero ‘0’. For example, if the first and second patterns 106 and 108′ are spaced apart from each other by the distance P and the distance P is identical to a designed interval, the misaligned value between the first and second patterns 106 and 108′ is ‘0’. The misaligned samples may be wafers having misaligned values between the first and second patterns 106 and 108′ greater than ‘0’. If a plurality of misaligned samples are used, the misaligned samples have misaligned values that may be different from each other. For example, if there are three misaligned samples, the first misaligned sample may have a misaligned value of 5 nm, and the second and third misaligned samples may have misaligned values of 10 nm and 15 nm, respectively. The number of misaligned samples and the misaligned values for those misaligned samples may vary.

The reference and misaligned samples may be identified and/or prepared, after the first and second patterns 106 and 108′ are formed on the wafer, by confirming the misaligned values between the first and second patterns 106 and 108′ using various inspecting instruments. For example, a scattering electron microscope, scanning electron microscope (SEM), etc., may be used to confirm the misaligned values of the reference and misaligned samples. The reference and misaligned samples may be provided with previously measured misaligned values.

The method of measuring overlay according to an example embodiment of the present invention shown in FIG. 4a also includes obtaining reference sample data and misaligned sample data S210 based on scattering measurements of the reference sample and misaligned samples. For example, the reference sample is loaded on the wafer chuck 110 of the scattering measurement block 100, the light source 120 irradiates light to the reference sample, and the detector 130 senses a physical quantity of the light scattered from the reference sample. Data taken from the reference sample by the detector 130, for example, the physical quantity, may be used as the reference sample data. The reference sample data may be at least one of intensity of P-polarized light, a phase difference of P-polarized light, intensity of S-polarized light, and phase difference of S-polarized light.

Similar to the reference sample, each of the misaligned samples may be loaded on the wafer chuck 110, the light source 120 may irradiate light to the misaligned sample, and the detector 130 may sense a physical quantity of the light scattered from the misaligned sample. Here, data taken from the misaligned sample by the detector 130, for example, the physical quantity, may be used as the misaligned sample data. Misaligned sample data may be obtained for each of the one or more misaligned samples. The misaligned sample data may be the same physical quantity of light used to obtain the reference sample data. A plurality of misaligned sample data may correspond to a single reference sample data. The reference and misaligned sample data obtained from the scattering measurement block 100 may be stored in the storage unit 160 of the controller 150.

If a single physical quantity of scattered light is measured by the detector 130, one reference sample data may be obtained. However, if a plurality of physical quantities of scattered light are measured by the detector 130, a plurality of reference sample data may be prepared.

First, an example where a single physical quantity of light is used to obtain reference sample data used to measure overlay between a first pattern and second pattern is described.

The method of measuring overlay according to the example embodiment of the present invention shown in FIG. 4a includes assigning fitting values related to the misaligned values by comparing the reference sample data with the plurality of corresponding misaligned sample data S220. Each of the reference fitting values may be assigned a value representing the difference between the reference sample data and each of the misaligned sample data. During this operation, the reference fitting value of the reference sample, which has a misaligned value of ‘0’) may be defined as ‘1’. In other words, the reference fitting values may be defined by subtracting the normalized values, which may be established based on the difference between the reference sample data and the misaligned sample data, from ‘1’. The reference fitting values may be evaluated by the control operation unit 155 of the controller 150.

The light from the light source 120 may have multi-wavelength domains. If the light from the light source 120 has multi-wavelength domains, the difference between the reference and misaligned sample data may have a plurality of classified wavelengths. In this case, the normalization can be completed after summing the plurality of values of the differences.

The method of measuring overlay according to the example embodiment of the present invention shown in FIG. 4a includes creating a reference table with the misaligned values and reference fitting values S230. The reference table may be completed by correlating the misaligned values with the corresponding reference fitting values. The control operation unit 155 may generate the reference table, and the storage unit 160 may retain and/or store the reference table.

Table 1 is an example of a reference table generated based on the assumption that the first, second, and third misaligned values are 5 nm, 10 nm, and 15 mm, respectively. The reference fitting values shown in Table 1 are optionally established for convenience of description.

TABLE 1

| Misaligned value (nm) | Reference fitting value |
|---|---|
| 0 | 1 |
| 5 | 0.98 |
| 10 | 0.96 |
| 15 | 0.94 |

As mention above, the light source 120 may be operable in multi-wavelength domains. For example, the light source 120 may be set to irradiate P or S-polarized light with multi-wavelength domains. In this case, a method of overlay measurement according to an example embodiment of the present invention may include setting a wavelength domain of light used to obtain a scattering measurement of a wafer to be measured, which is referred to herein as a target wafer 240.

Setting the wavelength domain may be executed by repeating operations S210 through S230 shown in FIG. 4a using light in the different wavelength domains and analyzing the results. The operation of setting the wavelength domain will now be explained.

First, the scattering measurement block 100 may obtain a plurality of wavelength-classified reference sample data and a plurality of misaligned sample data corresponding to each of the wavelength-classified reference sample data by obtaining scattering measurements for the reference and corresponding misaligned samples using light in different wavelength domains. Namely, the operation S210 may be repeated a plurality of times, each time using light in a different wavelength domain. The obtained wavelength-classified reference sample data and the corresponding misaligned sample data may be stored in the storage unit 160.

Then, a wavelength-classified fitting value group may be developed. The wavelength-classified fitting value group may include reference fitting values from each of the wavelength-classified reference sample data and the corresponding plurality of misaligned sample data. The assigning operation S220 may be repeated with light in the different wavelength domains. The wavelength-classified fitting value group may be evaluated by the control operation unit 155.

A wavelength-classified reference table may then be created from the reference fitting values of each of the wavelength-classified fitting groups and the corresponding misaligned values. Namely, operation S230 may be repeated with the plurality of wavelength-classified fitting value groups, so that a plurality of wavelength-classified reference tables may be created. The wavelength-classified reference tables may be created by the control operation unit 155 and may be stored in the storage unit 160.

Next, one of the plurality of wavelength-classified fitting value groups may be selected. The selection may be made based on which of the wavelength-classified fitting value groups is most qualified for linearity regarding a relation between the reference fitting values and the misaligned values. The most qualified wavelength-classified fitting value group may correspond to a highest degree of proportionality between the misaligned values and corresponding reference fitting values. That is, the relation between the reference fitting values and the misaligned values are generally distributed according to an approximately linear function. The wavelength domain of the selected fitting value group may be set as an optimum wavelength domain in the operation S240 shown in the example embodiment of the present invention shown in FIG. 4a. The control operation unit 155 may comparatively analyze the misaligned and reference fitting values of the wavelength-classified fitting value groups and may select the fitting value group that is associated with the most linear function between the misaligned and reference fitting values. The selected wavelength-classified fitting value group may be stored in the storage unit 160.

The method of measuring overlay according to the example embodiment of the present invention shown in FIG. 4a includes obtaining scattering data for a target wafer S250. The target wafer may be loaded on the wafer chuck 110 and the light source 120 may irradiate light on the target wafer 105. The detector 130 may sense the physical quantity of the light scattered from the target wafer 105. The detected physical quantity may be used as the scattering data of the target wafer 105. The scattering data of the target wafer 105 may be a physical quantity having the same components as the reference and misaligned sample data used to create the reference table created in operation S230. In order to obtain the scattering data, the irradiated light may be associated with the wavelength domain selected in operation S240.

The scattering data of the target wafer may be transferred to the controller 150 and may be stored in the storage unit 160.

The method of measuring overlay according to an example embodiment of the present invention shown in FIG. 4a includes evaluating a fitting value for the target wafer based on a difference between the reference sample data and the scattering data of the target wafer S260. The fitting value of the target wafer may be counted by the control operation unit 155 and may be stored in the storage unit 160.

The method of measuring overlay according to an example embodiment of the present invention may include comparing the fitting value of the target wafer with a created reference table S270. By comparing the fitting value of the target wafer with the reference fitting values of the reference table, the reference fitting value which is closest to the fitting value of the target wafer may be determined. The fitting value assigned to the target wafer may be referred to as the target fitting value. For example, the control operation unit 155 may find the reference fitting value that is identical or closest to the target fitting value by comparing the target fitting value with the reference fitting values of the reference table. When a wavelength domain of light is selected, the selected wavelength-classified reference table may be the reference table compared with the target fitting value.

The method of measuring overlay according to the example embodiment of the present invention shown in FIG. 4a may include determining a misaligned value of the target wafer S280. The misaligned value of the target wafer, which is referred to as the target misaligned value herein, may be determined from a misaligned value corresponding to a reference fitting value that is identical or closest to the target fitting value. Determining the target misaligned value may also include an operation of applying the proportional relation with the reference fitting and misaligned values thereto. The control operation unit 155 may determine the target misaligned value.

As stated above, from the reference and misaligned sample data, the reference fitting values may be obtained and correspond with the misaligned values. This makes it easy to model the misaligned and reference fitting values. Thus, example embodiments of the present invention provide a method and system of measuring overlay that may improve reliability in determining misaligned values of the first and second patterns. Accordingly, although the first and second patterns may be disposed within a chip area, it is possible to conduct the overlay measurement. As a result, the overlay measuring system and method according to example embodiments of the present invention may be able to confirm an alignment state of patterns in a semiconductor device chip.

An example embodiment of the present invention will now be described, wherein a plurality of the reference sample data and a plurality of physical quantities are used, with reference to the flow chart shown in FIGS. 4a and 4b.

Referring to FIGS. 1, 3, 4a and 4b, the reference and misaligned samples may be sequentially loaded in the scattering measurement block 100. And then, a plurality of reference sample data each corresponding to one or more of the plurality of physical quantities, and a plurality of the misaligned sample data each corresponding to the reference sample data may be obtained S210. As previously mentioned, the plurality of physical quantities may be selected from intensity of the P-polarized light, phase difference of the P-polarized light, intensity of the S-polarized light, and phase difference of the S-polarized light. The obtained data may be stored in the storage unit 160.

A plurality of reference fitting value groups may be evaluated S220. Each of the reference fitting value groups may include reference fitting values corresponding to the misaligned values and being evaluated from each of the reference sample data and the plurality of misaligned sample data corresponding to each of the reference sample data. The plurality of reference fitting value groups correspond to the physical quantities. the control operation unit 155 may evaluate the plurality of reference fitting value groups.

A reference table may be created using the misaligned and reference fitting values included in each of the reference fitting value groups S230. A plurality of reference tables may be created, each corresponding to one or more reference fitting value groups. The reference tables may be generated by the control operation unit 155 and may be stored in the storage unit 160.

According to an example embodiment of the present invention, weight values may be assigned to each of the reference fitting value groups S235. The weight values may be represented in the form of a percentage. The physical quantities may vary depending on the configurations of materials under the first and second patterns 106 and 108′ and the characteristics and/or materials of the first and second patterns 106 and 108′. For example, the weight value of each of the reference fitting value groups may be established in accordance with the variation amounts or rates of the physical quantities that depend on the distance P between the first and second patterns 106 and 108′. As the variation amounts of the physical quantities become highly sensitive to the distance P, the weight values of the reference fitting value groups become higher. On the other hand, as the variation amounts of the physical quantities are increasingly sensitive to other factors (e.g., the material under the patterns, configurations of the patterns, properties of the patterns, etc.) instead of the distance P, the weight values of the reference fitting value groups become lower. Setting the weight values may be carried out by the control operation unit 155. The sensitivity of the physical quantities may be observed through experiments. The weight values of the reference fitting value groups may be stored in the storage unit 160.

Next, the wavelength domains of light may be defined that correspond with each of the plurality of reference sample data S240. That is, from conducting the scattering measurement to the reference and misaligned samples with light different in wavelengths, a plurality of wavelength-classified reference sample data may be obtained corresponding to each of the physical quantities, and a plurality of the misaligned sample data may be obtained corresponding to each of the wavelength-classified reference sample data. The control operation unit 155 may evaluate the wavelength-classified fitting value group including a plurality of reference fitting values corresponding with the misaligned values. The plurality of reference fitting values may be evaluated from each of the wavelength-classified reference sample data and the plurality of misaligned sample data corresponding to each of the wavelength-classified reference sample data. A plurality of the wavelength-classified fitting value groups may be evaluated with each of the physical quantities. Then, the control operation unit 155 may select one of the plurality of wavelength-classified fitting value groups for each of the physical quantities. The selected one of the plurality of wavelength-classified fitting value groups may be selected for linearity between the reference fitting values and misaligned values. And, a wavelength domain may be selected for the selected wavelength-classified fitting value group. The selected wavelength-classified fitting value group corresponding to each of physical quantities may correspond with the reference fitting value group corresponding to each of physical quantities. The control operation unit 155 may evaluate and comparatively analyze the wavelength-classified fitting value groups and may select the most linear one of the wavelength-classified fitting value groups.

The target wafer may be loaded on the wafer chuck 110 in the scattering measurement block 100, and thereby the scattering data may be obtained from the target wafer S250. During this operation, scattering data may be obtained for the target wafer for each of the physical quantities being measured.

Then, fitting values for the target wafer may be evaluated with the plurality of reference fitting value groups S260. Namely, the target fitting values may be obtained by comparing the reference sample data with the scattering data of the target wafer. The plurality of target fitting values obtained may be counted by the control operation unit 155 and then stored in the storage unit 160.

Thereafter, the target fitting values may be compared with the reference tables S260. Through the comparison, a reference fitting value may be identified that is identical or closest to the target fitting values. Thus, pluralities of the reference fitting values may be found. The control operation unit 155 may compare the target fitting values with the reference tables.

Next, preliminary misaligned values may be determined that correspond with the target fitting values. The misaligned value of the target wafer may be determined from applying and summing the weight values of the reference fitting value groups on the preliminary misaligned values. The misaligned value of the target wafer may be determined by the control operation unit 155.

By employing the weight values of the plurality of reference fitting value groups, the effects of the variation rates of the fitting values based on other factors may be reduced and/or minimized. Accordingly, example embodiments of the present invention may enhance the reliability of the misaligned values for the target wafer.

As described above, according to example embodiments of the present invention, the reference fitting values for the misaligned values may be evaluated using one or more reference samples and the one or more misaligned samples. Accordingly, a modeling operation between the misaligned and reference fitting values may be easily executed. Further, as the scattering measurement block is provided to obtain the physical quantities by the scattering of light, the resolution of fine patterns may be increased. In addition, the overlay measurement of example embodiments of the present invention utilizes a way of extracting data through the scattering of light, instead of directly inspecting values thereof, so that it is possible to obtain data for overlay regardless of configurations of the patterns that are provided for measuring the overlay state. As a result, the overlay measurement according to the example embodiments of the present invention is able to directly check an alignment state of the real patterns disposed within the chip area.

Moreover, using a plurality of reference sample data and the weight values of the plurality of reference fitting value groups, it is possible to reduce and/or minimize the variation rates of the fitting values by other factors such as the materials and configuration relevant to the patterns, for example. Therefore, example embodiments of the present invention enhance the reliability of the misaligned values for the wafer to be inspected.

The above described example embodiments of the present invention are to be considered illustrative, and not restrictive. The appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of measuring overlay between a first pattern and a second pattern of a target wafer comprising:
obtaining reference sample data and misaligned sample data from scattering data of a reference sample and at least one misaligned sample, respectively;
assigning reference fitting values based on the reference sample data and the misaligned sample data;
collecting target wafer scattering data from a target wafer;
evaluating a target wafer fitting value based on the reference sample data and the target wafer scattering data; and
comparing the target wafer fitting value with the reference fitting values to determine a target wafer misaligned value relating to the overlay between the first pattern and the second pattern of a target wafer.

2. The method as set forth in claim 1, further comprising:
preparing a reference sample having a misaligned value between the first and second pattern that is zero and a plurality of misaligned samples having misaligned values between the first and second patterns larger than zero and each of the plurality of misaligned samples has a misaligned value different from other misaligned samples.

3. The method as set forth in claim 1, wherein obtaining the reference sample data and the misaligned sample data includes
conducting a scattering measurement on the reference sample with light to obtain the reference sample data; and
conducting a scattering measurement on the at least one misaligned sample with light to obtain the misaligned sample data.

4. The method as set forth in claim 1, wherein obtaining the reference sample data and the misaligned sample data includes:
obtaining a plurality of wavelength-classified reference sample data by scattering measurements of the reference sample performed with a plurality of light different in wavelength domains; and
obtaining the misaligned sample data by scattering measurement to the misaligned samples performed with the plurality of light different in wavelength domains, the misaligned sample data including a plurality of misaligned sample data corresponding to each of the wavelength-classified reference sample data,
wherein assigning the reference fitting values includes assigning a plurality of wavelength-classified fitting value groups, and each of the wavelength-classified fitting value groups includes a plurality of the reference fitting values based on each of the wavelength-classified reference sample data and a plurality of misaligned sample data corresponding to each of the wavelength-classified reference sample data,
the method, further comprising: selecting one of the wavelength-classified fitting value groups based on the most qualified linearity of a relation between the misaligned values and the reference fitting values

5. The method as set forth in claim 1, wherein the reference sample data and the misaligned sample data are data related to at least one physical quantity selected from intensity of P-polarized light, phase difference of P-polarized light; intensity of S-polarized light, and phase difference of S-polarized light, being detected after scattering.

6. The method as set forth in claims 5, wherein a plurality of the physical quantities are used to measure overlay,
wherein a plurality of the reference sample data are obtained by a plurality of the physical quantities, respectively,
wherein a plurality of the misaligned sample data corresponding to each of the reference sample data are obtained,
wherein assigning the reference fitting values includes assigning a plurality of reference fitting value groups, and each of the reference fitting value groups includes a plurality of the reference fitting values based on each of the reference sample data and a plurality of the misaligned sample data corresponding to each of the reference sample data.

7. The method as set forth in claim 6, further comprising:
setting weight values of percentage to each of the reference fitting value groups.

8. The method as set forth in claim 7, wherein evaluating the target wafer fitting value and determining the target wafer misalignment value includes,
evaluating the target wafer fitting values in correspondence with the reference fitting value groups, respectively;
comparing the target wafer fitting values with the reference fitting value groups to determine preliminary misaligned values to determine the misaligned value of the target wafer.

9. The method as set forth in claim 7, wherein obtaining the reference sample data and the misalign sample data includes,
obtaining a plurality of wavelength-classified reference sample data in correspondence with each of the physical quantities, the plurality of wavelength-classified reference data obtained by scattering measurement to the reference sample with a plurality of light different in wavelength domains; and
obtaining a plurality of the misaligned sample data corresponding to each of the wavelength-classified reference sample data and being obtained by scattering measurement to the misaligned samples with the plurality of light,
wherein assigning the reference fitting values includes evaluating a plurality of wavelength-classified fitting value groups, and each of the wavelength-classified fitting value groups includes a plurality of the reference fitting values based on each of the wavelength-classified reference sample data and a plurality of the misaligned sample data corresponding to each of the wavelength-classified reference sample data,
the method, further comprising: selecting one of the wavelength-classified fitting value groups corresponding to each of the physical quantities, which is based on the most qualified linearity with a relation between the misaligned values and the reference fitting values,
wherein the selected wavelength-classified fitting value group is correspondent with each of the reference fitting value groups.

10. The method as set forth in claim 1, wherein the reference fitting values are determined using a normalized value for a difference between the reference sample data and the misaligned sample data and the reference fitting value of the reference sample is 1.

11. The method as set forth in claim 1, which further comprising:
creating a reference table including misaligned values and the reference fitting values.

12. The method as set forth in claim 1, wherein the first and second patterns are selected from real patterns in chip areas and overlay patterns in scribing lines.

13. The method as set forth in claim 1, wherein the first pattern is covered by a material film and the second pattern is arranged on the material film.

14. The method as set forth in claims 1, wherein the first and second patterns are arranged on the same level.

15. A system for measuring overlay between a first pattern and a second pattern, comprising:
a scattering measurement block obtaining reference sample data by measuring light scattering from a reference sample having a misaligned value of zero, obtaining misaligned sample data by measuring a plurality of misaligned samples having misaligned values larger than zero and different from each other, and obtaining target wafer scattering data;
a storage unit storing data obtained by the scattering measurement block; and
a control operation unit assigning reference fitting values based on the reference sample data and the misaligned sample data, evaluating a target wafer fitting value based on the target wafer scattering data and the reference fitting values, and comparing the target wafer fitting value to determine a target wafer misaligned value relating to the overlay between the first pattern and second pattern of the target wafer.

16. The system as set forth in claim 15, wherein the scattering measurement block obtains a plurality of wavelength-classified reference sample data and a plurality of the misaligned sample data corresponding to each of the wavelength-classified reference sample data by scattering measurement to the reference sample and the plurality of misaligned samples using light different in wavelength domains,
wherein the control operation unit evaluates a plurality of wavelength-classified fitting value groups, each of the wavelength-classified fitting value groups including the assigned reference fitting values from each of the wavelength-classified reference sample data and the plurality of the misaligned sample data, and
wherein the control operation unit selects one of the wavelength-classified fitting value groups based on linearity of a relation between the misaligned values and the reference fitting values.

17. The system as set forth in claim 15, wherein the scattering measurement block comprises:
a wafer chuck on which the reference sample, the misaligned samples and the target wafer are loaded;
a light source irradiating light toward the wafer chuck; and
a detector sensing a physical quantity used as the reference sample data, the misaligned sample data, and the target wafer scattering data,
wherein the physical quantity is one of intensity of P-polarized light, phase difference of P-polarized light, intensity of S-polarized light, and phase difference of S-polarized light.

18. The system as set forth in claim 17, wherein the detector senses a plurality of the physical quantities;
wherein the scattering measurement block obtains a plurality of the reference sample data each corresponding to one of the physical quantities, and obtains a plurality of the misaligned sample data corresponding to each of the reference sample data; and
wherein the control operation unit evaluates a plurality of wavelength-classified fitting value groups, each of the wavelength-classified fitting value groups including a plurality reference fitting values evaluated from each of the reference sample data and the plurality of the misaligned sample data corresponding each of the reference sample data, and the control operation unit sets weight values of percentage to each of the reference fitting value groups.

19. The system as set forth in claim 18,
wherein the control operation unit extracts a preliminary fitting value of the target wafer for each wavelength fitting value group, compares the preliminary fitting values of the target wafer with the reference fitting value groups to determine preliminary misaligned values of the target wafer, and applies the weight values to the preliminary misaligned values to determine the target wafer misaligned value.

20. The system as set forth in claim 15, wherein the reference fitting values are determined using a normalized value for a difference between the reference and misaligned sample data and the reference fitting value of the reference sample is 1.

21. The system as set forth in claim 15, wherein the control operation unit creates a reference table including misaligned values and the reference fitting values and the storage unit stores the reference table.
